(19) United States
(12) Patent Application Publication
(10) Pub. No.: US 2023/0174423 A1
(43) Pub. Date: Jun. 8, 2023

(54) GLASS WAFER WITH THROUGH GLASS VIAS

(71) Applicant: CORNING INCORPORATED, Corning, NY (US)

(72) Inventors: Dorothy Roberta Behan, Corning, NY (US); Donald Seton Farquhar, Niskayuna, NY (US); Uta-Barbara Goers, Campbell, NY (US); Tammy Lynn Petriwsky, Elmira, NY (US)

(21) Appl. No.: 18/076,849

(22) Filed: Dec. 7, 2022

Related U.S. Application Data
(60) Provisional application No. 63/287,285, filed on Dec. 8, 2021.

(51) Int. Cl. C03C 23/00; C03C 3/06; C03C 17/06; C03C 17/00

(52) U.S. Cl. CPC C03C 23/007; C03C 3/06; C03C 17/06; C03C 17/004; C03C 2201/02; C03C 2203/52; C03C 2217/25; C03C 2218/32

(57) ABSTRACT

A wafer including a glass substrate is provided. The glass substrate includes a first surface defining a plane and including a surface roughness Rₐ of approximately 0.3 nm in an outer via region and a second surface. The glass substrate defines a plurality of vias extending from the first surface. The plurality of vias each include an entrance defined by the first surface.

### CROSS REFERENCE TO RELATED APPLICATION

This application claims the benefit of priority under 35 U. S.C. § 119 of U.S. Provisional Application Ser. No. 63/287,285 filed on Dec. 8, 2021, the content of which is relied upon and incorporated herein by reference in its entirety.

### BACKGROUND

The present disclosure generally relates to a glass substrate, such as a glass wafer, having through glass vias (TGVs). Specifically, the present disclosure is directed to glass wafers having through glass vias with a desired morphology and dimensional tolerances.

Dimensions of the TGVs may vary from via to via as a result of variations in the laser process, the etch process, and material used. Specific nominal hole dimensions and shapes must be in a predetermined range. If the range is exceeded, this may limit the overall product performance and also reduce production yield. Furthermore, when the range is exceeded corrective actions may include additional measurements and process controls, thereby resulting in lost time, capacity and increased cost.

The vias may be metallized to provide interconnections between a first surface and a second surface. Smaller diameter vias are beneficial for reducing spacing requirements and for the metallization process to hermetically seal the vias. Vias having too rough of an interior wall surface may cause electrically conductive material to not adhere to the interior wall surfaces during the metallization process or may delaminate in subsequent service, which may compromise various aspects of function and reliability.

### SUMMARY

According to one embodiment of the present disclosure, a wafer including a glass substrate is provided. The glass substrate includes a first surface defining a plane and including an average surface roughness Rₐ of approximately 0.3 nm in an outer via region, wherein the average surface roughness Rₐ of the plane in the outer via region is an average of at least five measurements, and a second surface. The glass substrate defines a plurality of vias extending from the first surface. The plurality of vias each include an entrance defined by the first surface and including an entrance diameter and an interior sidewall proximate the entrance. A ratio of a depression depth to the entrance diameter of the plurality of vias is not greater than 0.0006. The depression depth is measured from the plane to a transition point from a depressed region to the interior sidewall. The outer via region is at least 250 μm from any one of the plurality of vias.

According to another embodiment of the present disclosure, a wafer including a glass substrate is provided. The glass substrate includes a first surface defining a first plane including an average surface roughness Rₐ of approximately 0.3 nm in an outer via region, wherein the average surface roughness Rₐ of the first plane in the outer via region is an average of at least five measurements, and a second surface defining a second plane. The glass substrate defines a plurality of vias extending from the first surface to the second surface. The plurality of vias each include a first opening defined by the first surface and including a first diameter and a second opening defined by the second surface and including a second diameter. The second opening is fluidly coupled to the first opening. An interior sidewall is disposed between the first opening and the second opening. A depressed region surrounds the first opening and includes a surface roughness Rₐ of less than 0.6 nm, wherein the average surface roughness Rₐ of the depressed region is an average of at least five measurements. The outer via region is at least 250 μm from any one of the plurality of vias. A ratio of a depression depth to the first diameter of the plurality of vias is not greater than 0.0006. The depression depth is measured from the first plane to a transition point from the depressed region to the interior sidewall.

According to yet another embodiment of the present disclosure, a method of forming a glass wafer is provided. The method includes providing a glass substrate including a surface defining a plane and an average surface roughness Rₐ of approximately 0.15 nm, wherein the average surface roughness Rₐ of the plane is an average of at least five measurements. The method further includes applying pulsed laser beams to the glass substrate to form a plurality of laser damage lines within the glass substrate. The glass substrate is etched in an etching solution to enlarge the plurality of laser damage lines to form a plurality of vias within the glass substrate. A ratio of a depression depth to an entrance diameter of the plurality of vias is not greater than 0.0006. The depression depth is measured from the plane defined by the surface to a transition point from a depressed region to an interior sidewall of the plurality of vias.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiments, and together with the description serve to explain principles and operation of the various embodiments.

### BRIEF DESCRIPTION OF THE DRAWINGS

FIG. 1 is a top, perspective schematic view of a glass wafer having a plurality of vias according to various aspects described herein;

FIG. 2 is a schematic cross-sectional view of a via through a glass wafer formed by a laser-damage-and-etch process according to various aspects described herein;

FIG. 3 is a schematic cross-sectional view of a hermetic metallized via through a glass wafer formed by a laser-damage-and-etch process according to various aspects described herein;

FIG. 4 is a schematic cross-sectional view of vias having depressed regions around openings of the holes according to various aspects described herein; and

FIG. 5 is a flow chart illustrating a method of forming a glass wafer according to various aspects described herein.

### DETAILED DESCRIPTION

Reference will now be made in detail to the present preferred embodiments, examples of which are illustrated in the accompanying drawings. Whenever possible, the same reference numerals will be used throughout the drawings to refer to the same or like parts.

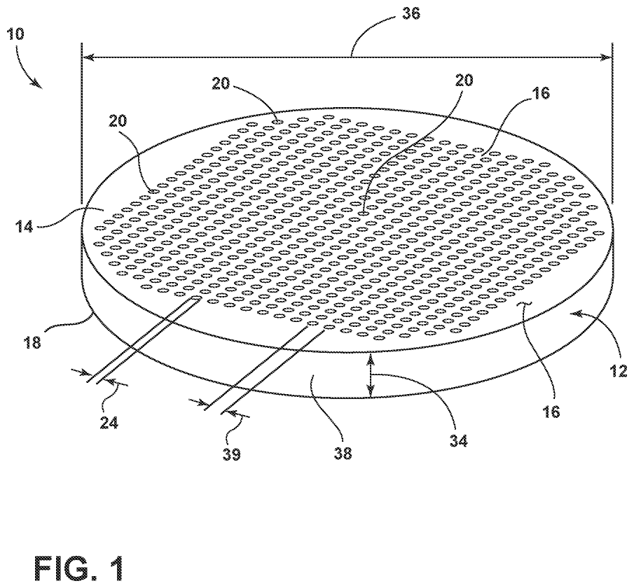

Referring to FIGS. 1-4, aspects of the present disclosure relate to a glass wafer 10. In some aspects, the glass wafer 10 may otherwise be referred to as wafer 10 including a glass substrate 12. The glass substrate 12 includes a first surface 14 defining a plane, P, and including a surface roughness, Rₐ, of approximately 0.3 nm in an outer via region 16 and a second surface 18. The glass substrate 12 defines a plurality of vias 20 extending from the first surface 14. The plurality of vias 20 each include an entrance 22 defined by the first surface 14 and including an entrance diameter 24. An interior sidewall 26 is proximate the entrance 22. A ratio of a depression depth 28 to the entrance diameter 24 of the plurality of vias 20 is not greater than 0.0006. The depression depth 28 is measured from the plane, P, to a transition point 30 from a depressed region 32 to the interior sidewall 26. The outer via region 16 is at least 250 μm from any one of the plurality of vias 20.

Referring now to FIG. 1, the illustrative glass wafer 10 is substantially circular in shape and includes a wafer thickness 34 in a range of approximately 0.30-0.40 mm. More specifically, the wafer thickness 34 may include a range of approximately 0.300-0.330 mm. Further, the glass wafer 10 may include a wafer diameter 36 of approximately 200-300 mm (8-12 in) or another preferred production format. In specific examples, the glass wafer 10 includes a wafer diameter 36 of approximately 200 mm. The first surface 14 may be referred to as an A-side, while the second surface 18 may be referred to as a B-side of the glass wafer 10. The illustrated glass wafer 10 includes an annular edge 38, or a wafer edge, extending along the circumference, or perimeter, of the glass wafer 10. While FIG. 1 depicts a circular article for the glass wafer 10, it is to be understood that any shape and size of glass article may be used for the wafer 10. For example, the glass wafer 10 or the glass substrate 12 may be in the form of a sheet having any dimensions suitable for its end use (e.g. rectangle, square).

The glass wafer 10 may be made of a variety of materials selected to tailor thermal and elastic properties, including, but not limited to, fused silica, high purity fused silica (Corning) HPFS®, Eagle XG® fusion drawn glass, alkali-free silicate glasses, borosilicate glass, ultra-low expansion glass (e.g. SiO₂—TiO₂), alkali silicate glasses (e.g. Corning® Gorilla® glass, soda lime glass), and the like. The glass wafer 10 can be made by any suitable process. In some examples, the glass wafer 10 may be made by forming a large boule and coring the boule to include a desired shape (e.g. circular). Following a coring process, the boule may be wire-sawn into slices. Each slice may then be polished or etched to have a desired surface polish/finish and edge finishing for the glass wafer 10. In other examples, the glass wafer 10 may be made in a fusion drawing process forming glass sheets having a desired thickness. The glass sheets may be cut into a desired shape (e.g. circular) for the glass wafer 10.

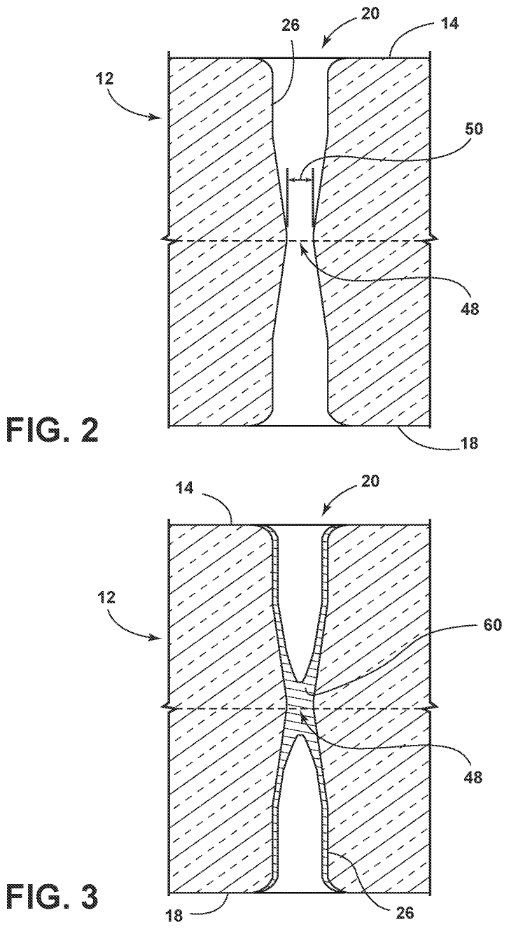

Referring now to FIGS. 1 and 2, the glass wafer 10 includes the plurality of vias 20, or holes. The glass wafer 10 may include any suitable number of vias 20, which may include approximately 50,000-100,000 vias 20. In specific examples, a glass wafer 10 may include a 200 mm wafer diameter 36 and approximately 100,000 vias 20. The vias 20 may be in any suitable shape. Examples of via 20 shape may include, but are not limited to, conformal pinch vias (CPVs), hourglass, cylindrical, conical, frustoconical, and the like. A pitch 39 of the vias 20 is the center-to-center spacing between adjacent vias 20 and may include any dimension suitable for the desired application. In some examples, the pitch 39 of the vias 20 is approximately 10 μm, 50 μm, 100 μm, 250 μm, 1000 μm, or within a range of varying pitch 52 from 10-2000 μm. The pitch 39 may not be smaller than the diameter of the via 20 without overlap of the vias 20. In some examples, a minimum pitch 39 may be expressed in terms of number of diameters (e.g. entrance diameter 24), and may be greater than or equal to two entrance diameters 24. In some implementations, the outer via region 16 may be at least 250 μm from any one of the plurality of vias 20. The surface roughness, Rₐ, in the outer via region 16 may be measured with atomic force microscopy (AFM), and, in some examples AFM using a 2.0 μm field of view (FOV). Further, surface roughness, Rₐ, in the outer via region 16 is an average value of at least two measurements, which, in specific implementations, includes any number of measurements in a range of approximately 5-10 measurements on two sides of one of the plurality of vias 20 in the outer region 16. The outer via region 16 may be located between adjacent vias 20 and/or between the vias 20 and the wafer edge 38. While FIG. 1 illustrates the plurality of vias 20 in a substantially uniform grid, it is within the scope of aspects described herein for the plurality of vias 20 to be clustered in repetitive patterns (e.g. small tiled areas). In some aspects, regions between clusters of the plurality of vias 20 may include a distance approximately greater than 250 μm. Moreover, within clusters of the plurality of vias 20 a via-to-via distance may be approximately 250 μm or less.

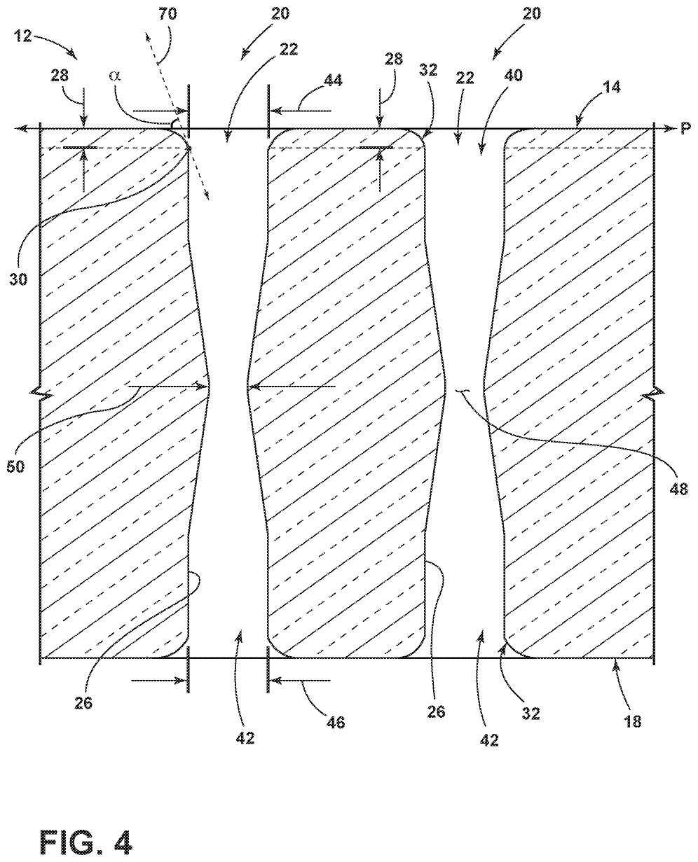

Referring now to FIG. 4, the entrance diameter 24 of one of the vias 20 may be calculated by finding a diameter of a least-squares best fit circle to edges of the entrance 22 to the via 20 as imaged by an optical microscope. The vias 20 may include more than one entrance 22 such that the vias 20 include a first opening 40 defined by the first surface 14 and a second opening 42 defined by the second surface 18. In some examples, the first opening 40 may be in the form of the entrance 24 and the second opening 42 may be in the form of an exit. The first opening 40 may include a first opening diameter 44, and the second opening 42 may include a second opening diameter 46. A pinch-shaped via 20 includes a narrow waist 48 having a waist diameter 50, which is less than the entrance diameter 24, first opening diameter 44, or second opening diameter 46 of the wafer 10. In some examples, the entrance diameter 24, first opening diameter 44, or second opening diameter 46 is in a nominal range of 45-55 μm with a standard deviation, σ, of approximately 1.16 μm or less. An average waist diameter 50 for the vias may be in a range of approximately 15-20 However, the average or nominal diameters are not limited to such and may be in any range suitable for the desired application.

As illustrated in FIGS. 2 and 4, the first opening 40 may be fluidly coupled to the second opening 42. In this way, the wafer 10 may not have been metallized such that the vias 20 are not hermetically sealed. The vias 20 may be formed by performing a laser damage process on the glass substrate 12 and subsequently etching the glass substrate 12 to form the vias 20 (i.e. through-vias).

As illustrated in FIG. 3, the via 20 is metallized and hermetically sealed. Metallization of the vias 20 provides electrically conductive paths through the glass wafer 10. Accordingly, a high electrical performance package may be produced, which can accommodate a high density of interconnects within a small package footprint. Metallizing and hermetically sealing the glass wafer 10 may include depositing an adhesion layer on the interior sidewall 26 of the via 20 followed by depositing a metal connector layer 60 to the adhesion layer. The adhesion layer may be deposited using any suitable technique such as, sputtering, ebeam deposition, ion beam deposition, atomic layer deposition, chemical vapor deposition, solution coating, and the like. In specific examples, the adhesion layer is deposited by sputtering titanium on the interior sidewall 26 of the via 20. The metal connector layer 60 may be deposited using any suitable technique, such as electroless deposition of a metal, electroplating a metal, filling the vias 20 with a metal paste and sintering, chemical vapor deposition (CVD), and the like. The metal connector layer 60 may include any suitable metal. In some examples, copper may be a desirable metal due to its particularly high conductivity. Gold, silver, and other conductive metals may be used, as well as alloys of conductive metals. In specific examples, the metal connector layer 60 consists essentially of copper. Moreover, the plurality of vias 20 may be electroplated with copper and include a plating thickness of approximately 10 μm. In some aspects, the waist 48 is completely filled with the metal connector layer 60.

The A-side (e.g. the first surface 14) via opening diameter (e.g. the first opening diameter 44) may be a key parameter for monitoring and controlling processing. The ratio of the A-side via opening diameter to B-side via opening diameter (e.g. the second opening diameter 46) is preferably 1:1, or approximately 1:1. Further, a relatively small waist diameter 50 is beneficial for sealing the vias 20 with copper plating (or other material). The waist diameter 50 is measured independently of A-side via opening diameter and B-side via opening diameter, but it is directly related to the A-side diameter via opening diameter.

FIG. 4 illustrates the depressed regions 32, or dimples, surrounding the entrances 22 in more detail. As previously discussed, the depression depth 28 is measured from the plane, P, to the transition point 30 from the depressed region 32 to the interior sidewall 26. The transition point 30 is the location of the start of the interior sidewall 26, which is determined by measuring an angle α between a tangent line 70 of the curved surface of the depressed region 32 and the plane, P. The location of the start of the interior sidewall 26, and therefore the location of the entrance 22 to the via 20, may be where the angle α is greater than 75 degrees. Accordingly, the depressed region 32 is a region in which all angles α may be less than 75 degrees. In some examples, the depression depth 28 is approximately 0.025 μm. As previously discussed, the entrance diameter 24, first opening diameter 44 or second opening diameter 46 may be in a nominal range of 45-55 μm. A ratio of the depression depth 28 to the entrance diameter 24 of the plurality of vias 20 may not be greater than 0.0006. In some aspects, a ratio of the depression depth 28 to the entrance diameter 24 of the plurality of vias 20 is not greater than 0.0009, not greater than 0.0008, and not greater than 0.0007. In other words, the ratio of the depression depth 28 to the entrance diameter 24 of the plurality of vias 20 is less than 0.0006, less than 0.0007, less than 0.0008, or less than 0.0009. For example, in the case where the depression depth 28 is 0.025 μm and the entrance diameter 24 is 50 μm, the ratio of the depression depth 28 to the entrance diameter 24 is 0.0005.

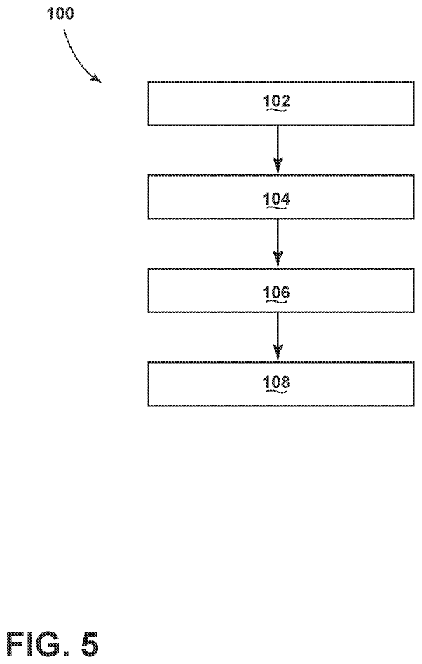

Referring now to FIG. 5, a flow chart of a method 100 of forming the glass wafer 10 is illustrated. The method 100 includes an initial step 102 of providing the glass substrate 12 including the surface 14 defining the plane, P. The glass substrate 12 may be made of high purity fused silica (Corning HPFS®). According to specific implementations, the surface 14 includes a surface roughness Rₐ of approximately 0.15 nm. However, the surface roughness Rₐ may be any suitable value and may be in a range of approximately 0.10-0.20 nm. Step 102 may also include the glass substrate 12 having a thickness in a range of approximately 0.30-0.40 mm. The method 100 may further include a step 104 of applying pulsed laser beams to the glass substrate 12 to form a plurality of laser damage lines within the glass substrate 12. Next, the glass substrate 12 may be etched in an etching solution to enlarge the plurality of laser damage lines to form the plurality of vias 20 within the glass substrate 12 at step 106. According to aspects described herein, the method 100 may result in the glass wafer 10 having the ratio of the depression depth 28 to the entrance diameter 24 of the plurality of vias 20 not being greater than 0.0006. As previously discussed, the depression depth 28 may be measured from the plane, P, defined by the surface 14 to the transition point 30 from the depressed region 32 to the interior sidewall 26 of the plurality of vias 20. Further, the method 100 may include an additional step 108 of metallizing and hermetically sealing the plurality of vias 20.

While described as including method steps 102-106, the method 100 may include any suitable steps, or procedures, for forming the glass wafer 10 having the plurality of vias 20. For example, the method 100 may include a polishing step prior to step 104 (i.e. an ultra-polishing step performed on a starting material). The polishing step may include a process for ultra-polishing the glass substrate 12. In this way, the ultra-polishing step may result in the glass substrate 12 including a surface roughness Rₐ of approximately 0.15 nm.

In some examples, the method 100 may result in the depressed regions 32 surrounding the entrances 22 having an average surface roughness Rₐ of less than 0.6 nm in a range from approximately 10-80 μm from the transition point 30. Average surface roughness Rₐ in the depressed regions 32 may include an overall average of multiple measurements, which may include at least five measurements of varying locations from front and rear areas of depressed regions 32 of at least two of the plurality of vias 20. Further, an average entrance diameter 24 of the plurality of vias 20 may be in a nominal range of 45-55 μm. Moreover, the method 100 may result in the nominal range of entrance diameters 24 for a sample of the plurality of vias 20 to exhibit a relatively narrow standard deviation. For example, in a sample of 1000 of the plurality of vias 20, the average entrance diameter 24 of 997 of the plurality of vias 20 may be within the nominal range of 45-55 μm. In addition, said 997 of the plurality of vias 20 may be in a range of 6 μm. By providing a plurality of vias 20 having tighter dimensional tolerances (e.g. exhibiting a relatively narrow standard deviation), nominal dimensions may be reduced, including average entrance diameter 24 and average waist diameter 50. Consequently, the glass wafers 10 may provide superior miniaturization and packaging efficiency. Furthermore, with a reduction to the central range (99.7%) of the via dimensions (e.g. average entrance diameter 24), downstream metallization and planarization processes are easier to control. For example, if the nominal waist diameter 50 is reduced, plating time (and consumption of plating chemistry) may be reduced. As plating process time extends until the largest diameter via is completed, a lower nominal waist diameter 50 and lower range are desirable for both product performance and for process efficiency.

Table 1, below shows results of one investigation of various parameters that are monitored to determine conformance of glass wafers. Table 1 shows that an improved A-side (e.g. the first surface 14) diameter central range of 99.7% is achieved using the glass wafers 10 (i.e. wafers formed from starting wafers having undergone the polishing step). Without wishing to be bound by theory, it is believed that the reduced standard deviation of the average entrance diameter 24 of the vias 20 is a direct result of reducing sub-surface damage (SSD) on the glass substrate 12 prior to step 104 (i.e. a starting wafer) as the presence of SSD may interact with both the laser and etch process. This may be explained by a reduction in pitting on the first and second surfaces 14, 18 (i.e. A-side and B-side) which results after step 106 (i.e. etching the vias) as SSD is not readily measurable. The reduced standard deviation of the average entrance diameter 24 of the vias 20 improves overall production yield. Improving overall production yield allows for reduced metrology sampling of roughness on depression region 32 surfaces that is typically associated with a laser damage and etch process.

TABLE 1

| | | | A-Side | |
|---|---|---|---|---|
| | | A-Side | Diameter | Count of |
| | | Diameter | Central | Pits and |
| | | Mean | 99.7% Range | Particles >5 |
| Wafer Type | Quantity | (μm) | (μm) | μm |
| Wafer 10 | 108 | 48.6 | 2.9 | 3,569 |
| Control Wafer | 15 | 48.4 | 6.7 | 14,205 |

Additionally, the method 100 may result in a surface roughness Rₐ in the depressed regions 32 of the vias 20 being smoother and shallower than typical depressed regions 32, or dimples. In some aspects, the surface roughness Rₐ in the depressed regions 32 of the vias 20 is different from the surface roughness Rₐ in the outer via regions 16. In one investigation, surface roughness Rₐ in two depressed regions 32 was measured with atomic force microscopy (AFM) using a 2.0 μm field of view (FOV) in five locations on the first surface 14 and the second surface 18 of one of the glass wafers 10. Surface roughness Rₐ in two depressed regions of a control glass wafer was also measured in five locations on each side of the glass control wafer. The AFM tip used was a ScanAsyst Air using a scan rate of 0.5 Hz and scan lines of 256×256.

Specifically, the locations measured ranged from approximately 10-80 μm from the transition point 30 as shown in Table 2, below. The difference between the control wafer and the glass wafer 10 is that the control wafer did not include a starting surface roughness Rₐ of approximately 0.15 nm prior to a laser damage and etch process (i.e. the starting control wafer did not undergo an ultra-polishing step). Table 2 shows that an improved final surface finish is achieved using starting wafers having undergone the polishing step. The average surface roughness Rₐ in the depressed regions 32 of the final glass wafer 10 according to aspects described herein was found to be less than 0.6 nm in a range from approximately 10-80 μm from the transition point 30. To the contrary, average surface roughness Rₐ in the depressed regions of the final control glass wafer was found to be approximately 0.8 nm in a range from approximately 10-80 μm from the transition point.

TABLE 2

| | Sample ID | | | | | | | |
|---|---|---|---|---|---|---|---|---|
| | Wafer 10 | | | | Control Wafer | | | |
| | Side | | | | | | | |
| | A | | B | | A | | B | |
| | Via | | | | | | | |
| | #1 | #2 | #1 | #2 | #1 | #2 | #1 | #2 |
| | Scan Location | | | | | | | |
| | Rₐ | Rₐ | Rₐ | Rₐ | Rₐ | Rₐ | Rₐ | Rₐ |
| | (nm) | (nm) | (nm) | (nm) | (nm) | (nm) | (nm) | (nm) |
| 10 um | 0.475 | 0.442 | 0.501 | 0.447 | 0.894 | 0.439 | 0.624 | 0.722 |
| 20 um | 0.439 | 0.533 | 0.441 | 0.377 | 0.573 | 0.887 | 0.779 | 0.775 |
| 40 um | 0.406 | 0.456 | 0.421 | 0.470 | 0.951 | 0.599 | 0.787 | 0.538 |
| 60 um | 0.502 | 0.635 | 0.669 | 0.493 | 0.794 | 1.310 | 0.492 | 0.785 |
| 80 um | 0.449 | 0.451 | 0.517 | 0.465 | 0.669 | 1.530 | 1.040 | 0.861 |
| Mean | 0.454 | 0.503 | 0.510 | 0.465 | 0.776 | 0.953 | 0.744 | 0.736 |
| StDv | 0.036 | 0.082 | 0.098 | 0.044 | 0.156 | 0.462 | 0.205 | 0.121 |

Table 3, below shows inspection data for another investigation including a sample of 256 of the glass wafers 10. The data shows that the glass wafers 10 do have very low average surface roughness Rₐ—on an order of 0.15 nm (measured with AFM using a 2 um FOV) on the starting material. Reduced sub-surface damage is indicated by the reduced count of pits (and in some examples, particles) after step 106 (i.e. the etching operation). One, or both, of the low average surface roughness Rₐ and reduced sub-surface damage characteristics appears to result in a laser damage track having less variability, thereby resulting in less entrance diameter 24 variation (e.g. 3σ value).

TABLE 3

| | Sample ID: | Control | Control | Wafer 10 |
|---|---|---|---|---|
| Quantity of Wafers | N | 50 | 168 | 256 |
| Incoming Rₐ (nm) | Average | 0.45 | 0.45 | 0.15 |
| Zeta Pits | Average | 16,303 | 8,766 | 3,382 |
| (count >5 μm | | | | |
| A-Side Diameter | Average; | 5.0; | 5.0; | 2.9; |
| Central 99.7% | (min, max) | (4.0, 7.1) | (2.8, 14.6) | (2.4, 5.9) |
| Range (μm) | | | | |
| Post-Etch Rₐ in | Average | 0.6 | 0.6 | 0.3 |
| outer via region | | | | |

The glass wafers 10 described herein can be used to improve efficiency during production of glass wafers with through glass vias 20. The glass wafers 10 according to various aspects described here may result in more than a 2× improvement in via dimension tolerance. The improvement of via dimension tolerance is of commercial value due to significant reduction in cost of production, thereby increasing customer value. In one example, the shape of the via entrance and exit (e.g. the first and second openings 40, 42) is an important factor for plating processes and product reliability. Minimizing the depth and roughness of the region around the via facilitates subsequent processing, including metallization. A key factor during TGV manufacture is to precisely control the via dimension (e.g. entrance diameter 24, waist diameter 50, depression depth 28) size range. Further, when manufacturing capability is higher, there is less disruption of the production line and an increase in predictable output. Improved process capability enables more efficient statistical monitoring techniques, which is advantageous from all aspects of lean production.

It will be apparent to those skilled in the art that various modifications and variations can be made without departing from the spirit or scope of the claims.

What is claimed is:

1. A wafer comprising:
a glass substrate comprising:
a first surface defining a plane and including an average surface roughness Rₐ of approximately 0.3 nm in an outer via region, wherein the average surface roughness Rₐ of the plane in the outer via region is an average of at least five measurements; and
a second surface;
the glass substrate defining a plurality of vias extending from the first surface, the plurality of vias each comprising:
an entrance defined by the first surface and including an entrance diameter; and
an interior sidewall proximate the entrance, wherein a ratio of a depression depth to the entrance diameter of the plurality of vias is not greater than 0.0006 and the depression depth is measured from the plane to a transition point from a depressed region to the interior sidewall, wherein the outer via region is at least 250 μm from any one of the plurality of vias.

2. The wafer of claim 1, wherein the depressed region surrounds the entrance and includes an average surface roughness Rₐ of less than 0.6 nm, wherein the average surface roughness Rₐ of the depressed region is an average of at least five measurements in a range from approximately 10-80 μm from the transition point.

3. The wafer of claim 1, wherein the depression depth is approximately 0.025 μm.

4. The wafer of claim 1, wherein the entrance diameter is in a nominal range of 45-55 μm.

5. The wafer of claim 4, wherein in a sample of 1000 of the plurality of vias the average entrance diameter of 997 of the plurality of vias is within the nominal range of 45-55 μm and the 997 of the plurality of vias are in a range of 6 μm.

6. The wafer of claim 1, wherein the wafer includes a wafer diameter of approximately 200 mm.

7. The wafer of claim 1, wherein the glass substrate comprises high purity fused silica.

8. The wafer of claim 1, wherein the wafer includes a wafer thickness in a range of approximately 0.300-0.330 mm.

9. The wafer of claim 1, wherein the plurality of vias are in the form of conformal pinch vias having an average waist diameter in a range of approximately 15-20 μm.

10. The wafer of claim 1, wherein the plurality of vias are metallized and hermetically sealed.

11. A wafer comprising:
a glass substrate comprising:
a first surface defining a first plane and including an average surface roughness Rₐ of approximately 0.3 nm in an outer via region, wherein the average surface roughness Rₐ of the first plane in the outer via region is an average of at least five measurements; and
a second surface defining a second plane;
the glass substrate defining a plurality of vias extending from the first surface to the second surface, the plurality of vias each comprising:
a first opening defined by the first surface and including a first diameter;
a second opening defined by the second surface and including a second diameter, the second opening fluidly coupled to the first opening;
an interior sidewall disposed between the first opening and the second opening;
a depressed region surrounding the first opening and including a surface roughness Rₐ of less than 0.6 nm, wherein the average surface roughness Rₐ of the depressed region is an average of at least five measurements; and
wherein the outer via region is at least 250 μm from any one of the plurality of vias, a ratio of a depression depth to the first diameter of the plurality of vias is not greater than 0.0006 and the depression depth is measured from the first plane to a transition point from the depressed region to the interior sidewall.

12. The wafer of claim 11, wherein the average surface roughness Rₐ of the depressed region is an average of at least five measurements in a range from approximately 10-80 μm from the transition point.

13. The wafer of claim 11, wherein the glass substrate comprises high purity fused silica.

14. The wafer of claim 11, wherein in a sample of 1000 of the plurality of vias the average first opening diameter of 997 of the plurality of vias is within a nominal range of 45-55 μm and the 997 of the plurality of vias are in a range of 6 μm.

15. A method of forming a glass wafer, the method comprising:
providing a glass substrate comprising a surface defining a plane and including an average surface roughness Rₐ of approximately 0.15 nm, wherein the average surface roughness Rₐ of the plane is an average of at least five measurements;
applying pulsed laser beams to the glass substrate to form a plurality of laser damage lines within the glass substrate; and
etching the glass substrate in an etching solution to enlarge the plurality of laser damage lines to form a plurality of vias within the glass substrate, wherein a ratio of a depression depth to an entrance diameter of the plurality of vias is not greater than 0.0006 and the depression depth is measured from the plane defined by the surface to a transition point from a depressed region to an interior sidewall of the plurality of vias.

16. The method of claim 15, wherein the depressed region surrounds entrances of the plurality of vias and includes an average surface roughness Rₐ of less than 0.6 nm, wherein the average surface roughness Rₐ of the depressed region is an average of at least five measurements in a range from approximately 10-80 μm from the transition point.

17. The method of claim 15, wherein providing a glass substrate further includes providing a glass substrate comprising a thickness in a range of approximately 0.30-0.40 mm.

18. The method of claim 15, wherein the entrance diameter is in a nominal range of 45-55 μm.

19. The method of claim 18, wherein in a sample of 1000 of the plurality of vias the average entrance diameter of 997 of the plurality of vias is within the nominal range of 45-55 μm and the 997 of the plurality of vias are in a range of 6 μm.

20. The method of claim 15, further comprising:
metallizing and hermetically sealing the plurality of vias.
